(19) United States
(12) Patent Application Publication
(10) Pub. No.: US 2018/0371345 A1
(43) Pub. Date: Dec. 27, 2018

(54) DETERGENT ADDITIVE FOR FUEL, AND COPOLYMERS USABLE IN SAID APPLICATION

(71) Applicant: TOTAL MARKETING SERVICES, Puteaux (FR)

(72) Inventor: Julie PREVOST, Lyon (FR)

(73) Assignee: TOTAL MARKETING SERVICES, Puteaux (FR)

(21) Appl. No.: 16/065,273

(22) PCT Filed: Dec. 19, 2016
(86) PCT No.: PCT/FR2016/053557

§ 371 Date: Jun. 22, 2018

(30) Foreign Application Priority Data
Dec. 22, 2015 (FR) 1563099

(51) Int. Cl. C10L 1/198; C10L 1/236; C10L 10/04; C08F 299/04; C08F 220/14; C08F 226/02

(52) U.S. Cl. CPC C10L 1/1983; C10L 1/2366; C10L 10/04; C10L 2230/08; C08F 220/14; C08F 226/02; C08F 299/0492

(57) ABSTRACT

The use of one or more copolymers as a detergent additive in a liquid fuel for internal combustion engines. The copolymer includes at least one repeat unit having an ester of alkyl or alkyl ester function and a repeat unit containing a diazotized hydrocarbon group. Also, specific copolymers including at least one repeat unit having an ester function of alkyl or alkyl ester function and a repeat unit containing a triazotized hydrocarbon group.

The present invention relates to the use of copolymers based on monomers comprising an ester function, for instance (meth)acrylates or olefinic alkylesters, and on monomers comprising a hydrocarbon-based function comprising at least two nitrogen atoms, preferentially three nitrogen atoms, as detergent additives in a liquid fuel for an internal combustion engine. The invention also relates to some of these copolymers, based on monomers comprising an ester function and on monomers comprising a hydrocarbon-based function comprising at least three nitrogen atoms. The invention also relates to a concentrate and a fuel composition containing such a copolymer.

### PRIOR ART

Liquid fuels for internal combustion engines contain components that can degrade during the functioning of the engine. The problem of deposits in the internal parts of combustion engines is well known to motorists. It has been shown that the formation of these deposits has consequences on the performance of the engine and in particular has a negative impact on consumption and particle emissions. Progress in the technology of fuel additives has made it possible to confront this problem. “Detergent” additives used in fuels have already been proposed to keep the engine clean by limiting deposits (“keep-clean” effect) or by reducing the deposits already present in the internal parts of the combustion engine (“clean-up” effect). Mention may be made, for example, of U.S. Pat. No. 4,171,959 which describes a detergent additive for gasoline fuel containing a quaternary ammonium function. WO 2006/135 881 describes a detergent additive containing a quaternary ammonium salt used for reducing or cleaning deposits, especially on the intake valves. However, engine technology is in constant evolution and the stipulations for fuels must evolve to cope with these technological advances of combustion engines. In particular, the novel gasoline or diesel direct-injection systems expose the injectors to increasingly severe pressure and temperature conditions, which promotes the formation of deposits. In addition, these novel injection systems have more complex geometries to optimize the spraying, in particular more numerous holes having smaller diameters, but which, on the other hand, induce greater sensitivity to deposits. The presence of deposits may impair the combustion performance and in particular increase pollutant emissions and particle emissions. Other consequences of the excessive presence of deposits have been reported in the literature, such as the increase in fuel consumption and maneuverability problems.

Preventing and reducing deposits in these novel engines are essential for optimum functioning of modern engines. There is thus a need to propose detergent additives for fuel which promote optimum functioning of combustion engines, especially for novel engine technologies.

There is also a need for a universal detergent additive that is capable of acting on deposits irrespective of the technology of the engine and/or the nature of the fuel. U.S. Pat. No. 4,508,882 describes vinyl benzotriazole monomers. These monomers may be used to form homopolymers and copolymers that can be used as UV absorbers. The examples describe random copolymers with methyl methacrylate, and with butyl acrylate. The copolymers are synthesized in toluene and are precipitated from methanol.

US 2012/041 040 describes 4- and 5-vinyl isomers of 1,2,3-triazole groups, these compounds being able to be used for the synthesis of various polymers that may be used in the following applications: adhesives, coatings, encapsulation, care products, petroleum extraction, membranes, agriculture, cleaning compositions, electronics, inks. The examples describe syntheses of random copolymers with methyl acrylate and methyl methacrylate. The copolymers are synthesized without solvent and then precipitated from methanol.

U.S. Pat. No. 2,945,006 describes layers of gelatin comprising an adduct of an aminoguanidine and of a polymeric carbonyl compound and the use thereof as fixatives in photography. It is envisaged to use copolymers of various carbonyl monomers with C1-C4 alkyl methacrylates, in particular in the experimental section of the random copolymers with MMA. The copolymers are synthesized in dioxane and then precipitated from a basic aqueous solution with acetone.

These documents do not concern the field of application of the invention and, moreover, it has been found that copolymers comprising short-chain alkyl ester units such as those described in the prior art are less efficient when compared with copolymers comprising C₆-C₃₄ alkyl ester units.

WO 2015/124 584 describes a fuel additive composition comprising at least one triazole derivative and at least one additive comprising a quaternary ammonium salt. This composition is used as a detergent for limiting deposits, especially of lacquering type, in a diesel engine. The triazole derivative may be grafted onto a polyisobutylene group, but it is not a matter of copolymers comprising a repeating unit comprising three nitrogen atoms.

### SUBJECT OF THE INVENTION

The invention relates to the use of copolymers based on monomers comprising an ester function, for instance alkyl esters, such as alkyl (meth)acrylates, or olefinic alkylesters, especially vinyl esters, and on monomers comprising a hydrocarbon-based group comprising at least two nitrogen atoms, preferably at least three nitrogen atoms, as detergent additives in a liquid fuel for an internal combustion engine. These copolymers may be used in the form of an additive concentrate.

The invention also relates to novel copolymers which may be used in this application, to a concentrate and to a fuel composition containing such copolymers.

The Applicant has discovered that certain families of copolymers, including the copolymers of the invention, have noteworthy properties as detergent additives in liquid fuels for internal combustion engines. The copolymers according to the invention used in these fuels can keep the engine clean, in particular by limiting or preventing the formation of deposits (“keep-clean” effect) and/or by reducing the deposits already present in the internal parts of the combustion engine (“clean-up” effect).

The advantages associated with the use according to the invention of such copolymers are:
optimum functioning of the engine,
reduction of the fuel consumption,
better maneuverability of the vehicle,
reduced pollutant emissions, and
savings due to less engine maintenance.

The subject of the present invention consequently relates to the use of a copolymer as detergent additive in a liquid fuel for an internal combustion engine, said copolymer comprising at least one repeating unit comprising an alkyl ester or alkylester function and at least one repeating unit comprising at least one hydrocarbon-based group comprising at least two nitrogen atoms, preferably at least three nitrogen atoms.

According to a preferred embodiment, the repeating unit comprising an alkyl ester or alkylester function is chosen from C₆-C₃₄ alkyl esters and C₆-C₃₄ alkylesters.

According to a preferred embodiment, the copolymer is obtained by copolymerization of at least:
one alkyl (meth)acrylate monomer (mₐ), and
one olefinic monomer (m_{b}) comprising at least one hydrocarbon-based group comprising at least two nitrogen atoms, preferably at least three nitrogen atoms.

According to a more preferred embodiment, the alkyl (meth)acrylate monomer (mₐ) is chosen from C₁ to C₃₄ alkyl (meth)acrylates, advantageously from C₆ to C₃₄ alkyl (meth)acrylates.

According to an advantageous embodiment, the vinyl monomer (m_{b}) comprising at least one hydrocarbon-based group comprising at least two nitrogen atoms corresponds to formula (I) below:

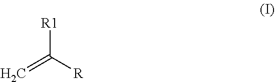

in which:
R represents a hydrocarbon-based chain comprising from 1 to 24 carbon atoms, comprising at least two nitrogen atoms, preferably at least three nitrogen atoms, optionally one or more hydroxyl substituents and optionally comprising one or more groups chosen from: an ether bridge —O—, an ester bridge —COO— and a carbonyl bridge —CO—,
one or more of the nitrogen atoms may be in the form of a quaternary ammonium, R1 represents H or CH₃.

Advantageously, the at least two nitrogen atoms are independently present in the group R in the form of a function chosen from: an amine —NH₂, an amine bridge —NH—, an imine bridge —N═, an amidine bridge —N═C—N—; a nitrile function —CN, an amide bridge —CONH—, a urea bridge —NH—CO—NH—, a carbamate bridge —O—CO—NH— and a guanidine, alkyl guanidine, aminoguanidine, biguanidine, polyamine or polyalkylene-polyamine group, and a quaternary ammonium.

According to a preferred variant, the monomer (m_{b}) is represented by formula (Ia):

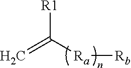

(Ia)
in which:
n represents an integer chosen from 0 and 1,
Ra represents a linear, branched or cyclic C₁-C₁₂ alkyl or C₂-C₁₂ alkenyl chain, optionally comprising one or more ether bridges —O—, an amine bridge —NH—, an imine bridge —N═, a carbonyl bridge —CO—, an ester bridge —COO—, a carboxyl bridge —OCO—, an amide bridge —CONH—, a urea bridge —NH—CO—NH—, a carbamate bridge —O—CO—NH—,
Rb represents a nitrogenous heterocycle comprising at least two nitrogen atoms, preferably at least three nitrogen atoms, one or more of the nitrogen atoms of Ra and/or of Rb may be in the form of a quaternary ammonium,
R1 represents H or CH₃.

According to this variant, advantageously, Ra represents a C₁-C₈ alkyl chain optionally comprising a carbonyl bridge —CO—, and Rb is chosen from rings comprising five atoms and rings comprising six atoms, these rings comprising two or three nitrogen atoms, and two, three or four carbon atoms.

According to another variant, the monomer (m_{b}) is represented by formula (Ia) in which:
n represents an integer chosen from 0 and 1,
Ra represents a group chosen from: an ether bridge —O—, an amine bridge —NH—, an imine bridge —N═, a carbonyl bridge —CO—, an ester bridge —COO—, a carboxyl bridge —OCO—, an amide bridge —CONH—, a urea bridge —NH—CO—NH—, a carbamate bridge —O—CO—NH—,
Rb represents a nitrogenous heterocycle comprising at least two nitrogen atoms, preferably at least three nitrogen atoms,
one or more of the nitrogen atoms of Ra and/or of Rb may be in the form of a quaternary ammonium,
R1 represents H or CH₃.

According to a preferred embodiment, the copolymer is a block copolymer.

According to a preferred embodiment, the copolymer is a block copolymer comprising at least:
one block A consisting of a chain of structural units derived from the alkyl (meth)acrylate monomer (mₐ), and
one block B₁ consisting of a chain of structural units derived from the olefinic monomer (m_{b}).

Advantageously, the copolymer is used in a concentrate for fuel comprising one or more copolymers as described hereinabove and hereinbelow, as a mixture with an organic liquid, said organic liquid being inert with respect to the copolymer(s) and miscible with said fuel.

According to another preferred embodiment, the copolymer is used in a fuel composition which comprises:
(1) a fuel derived from one or more sources chosen from the group consisting of mineral, animal, plant and synthetic sources, and
(2) one or more copolymers as described hereinabove and hereinbelow.

According to a preferred embodiment, the copolymer is used in the liquid fuel to keep clean and/or to clean up at least one of the internal parts of said internal combustion engine.

According to a preferred embodiment, the copolymer is used in the liquid fuel to avoid and/or reduce the formation of deposits in at least one of the internal parts of said engine and/or to reduce the existing deposits in at least one of the internal parts of said engine.

According to a preferred embodiment, the copolymer is used to reduce the fuel consumption of an internal combustion engine.

According to a preferred embodiment, the copolymer is used to limit or reduce or avoid or prevent pollutant emissions, in particular the particle emissions of an internal combustion engine.

According to a preferred embodiment, the internal combustion engine is a spark ignition engine.

Advantageously, according to this last embodiment, the copolymer is used to limit or reduce or avoid or prevent the formation of deposits in at least one internal part of a spark ignition engine chosen from the engine intake system, in particular the intake valves, the combustion chamber, the fuel injection system, in particular the injectors of an indirect injection system or the injectors of a direct injection system.

According to another preferred embodiment, the internal combustion engine is a diesel engine.

Advantageously, according to this last embodiment, the copolymer is used to limit or reduce or avoid or prevent the formation of deposits in the injection system of a diesel engine, preferably on an external part of an injector of said injection system, for example the fuel spray tip and/or on an internal part of an injector of said injection system, for example on the surface of an injector needle.

More advantageously, according to this last embodiment, the copolymer is used to limit or reduce or avoid or prevent the formation of deposits associated with coking and/or deposits of soap and/or lacquering type.

The invention also relates to a copolymer that may be used in the uses defined above, said copolymer comprising at least one repeating unit comprising an alkyl ester or alkylester function and at least one repeating unit comprising at least one hydrocarbon-based group comprising at least three nitrogen atoms.

According to a first variant, this copolymer is a block copolymer.

According to a preferred embodiment of the copolymer, the copolymer is obtained by copolymerization of at least:
one alkyl (meth)acrylate monomer (mₐ), and
one olefinic monomer (m_{b}) comprising at least one hydrocarbon-based group comprising at least three nitrogen atoms.

According to a second variant, the invention relates to a copolymer that may be used in the uses defined above, said copolymer being obtained by copolymerization of at least:
one C₆ to C₃₄ alkyl (meth)acrylate monomer,
   or
one vinyl alkylester monomer corresponding to the formula R′CO—O—CH═CH₂ with R′ a linear C₆ to C₃₄ alkyl,
   and
one olefinic monomer (m_{b}) comprising at least one hydrocarbon-based group comprising at least three nitrogen atoms.

According to this second variant, the copolymer may be a block copolymer or may be a statistical copolymer.

According to a more preferred embodiment of the copolymer, the vinyl monomer (m_{b}) comprising at least one hydrocarbon-based group comprising at least three nitrogen atoms corresponds to formula (I) below:

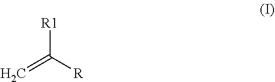

in which:
R represents a hydrocarbon-based chain comprising from 1 to 24 carbon atoms, comprising at least three nitrogen atoms, optionally one or more hydroxyl substituents and optionally comprising one or more groups chosen from: an ether bridge —O—, an ester bridge —COO— and a carbonyl bridge —CO—,
one or more of the nitrogen atoms may be in the form of a quaternary ammonium, R1 represents H or CH₃.

Advantageously, according to this embodiment of the copolymer, the at least three nitrogen atoms are independently present in the group R in the form of a function chosen from: an amine —NH₂, an amine bridge —NH—, an imine bridge —N═, an amidine bridge —N═C—N—, a nitrile function —CN, an amide bridge —CONH—, a urea bridge —NH—CO—NH—, a carbamate bridge —O—CO—NH— a guanidine, alkylguanidine, aminoguanidine, biguanidine, polyamine or polyalkylene-polyamine group, a quaternary ammonium.

According to a first preferred variant of the copolymer, the monomer (m_{b}) is represented by formula (Ia):

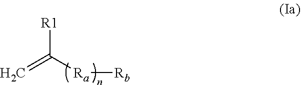

in which:
n represents an integer chosen from 0 and 1,
Ra represents a linear, branched or cyclic C₁-C₁₂ alkyl or C₂-C₁₂ alkenyl chain, optionally comprising one or more ether bridges —O—, an amine bridge —NH—, an imine bridge —N═, a carbonyl bridge —CO—, an ester bridge —COO—, a carboxyl bridge —O—, an amide bridge —CONH—, a urea bridge —NH—CO—NH—, a carbamate bridge —O—O—NH—,
Rb represents a nitrogenous heterocycle comprising at least three nitrogen atoms, one or more of the nitrogen atoms of Ra and/or of Rb may be in the form of a quaternary ammonium,
R1 represents H or CH₃.

Advantageously, according to this first preferred variant of the copolymer, Ra represents a C₁-C₈ alkyl chain optionally comprising a carbonyl bridge —CO—, and Rb is chosen from rings comprising five atoms and rings comprising six atoms, these rings comprising three nitrogen atoms, and two, three or four carbon atoms.

Advantageously, according to this first preferred variant of the copolymer, Rb is a triazole ring.

Advantageously, according to this first preferred variant of the copolymer, the monomer (m_{b}) is chosen from: 1-vinyl-1,2,3-triazole, 1-vinyl-1,2,4-triazole, vinylbenzotriazole, vinyladenine, vinyltriazine, 2,4-dimethyl-6-vinyltriazine, 2-vinyl-4,6-diamino-1,3,5-triazine.

According to a second preferred variant of the copolymer, the monomer (m_{b}) is represented by formula (Ib):

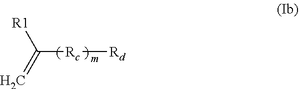

in which:
m represents an integer chosen from 0 and 1,
Rc represents a linear, branched or cyclic C₁-C₁₂ alkyl or C₂-C₁₂ alkenyl chain, optionally comprising one or more groups chosen from: an ether bridge —O—, an amine bridge —NH—, an imine bridge —N═, an ester bridge —COO—, a carbonyl bridge —CO—, an amide bridge —CONH—, a urea bridge —NH—CO—NH—, a carbamate bridge —O—CO—NH—,
Rd represents a group chosen from amidine, guanidine, aminoguanidine, biguanidine, polyamine and polyalkylene-polyamine groups,
one or more of the nitrogen atoms of Rc and/or of Rd may be in the form of a quaternary ammonium,
R1 represents H or CH₃.

According to a second preferred variant of the copolymer, the monomer (m_{b}) is represented by formula (Ib) in which:
m represents an integer chosen from 0 and 1,
Rc represents a group chosen from: an ether bridge —O—, an amine bridge —NH—, an imine bridge —N═, an ester bridge —COO—, a carbonyl bridge —CO—, an amide bridge —CONH—, a urea bridge —NH—CO—NH—, a carbamate bridge —O—CO—NH—,
Rd represents a group chosen from amidine, guanidine, aminoguanidine, biguanidine, polyamine and polyalkylene-polyamine groups,
one or more of the nitrogen atoms of Rc and/or of Rd may be in the form of a quaternary ammonium,
R1 represents H or CH₃.

According to a preferred embodiment of the copolymer, the copolymer is a block copolymer comprising at least:
one block A consisting of a chain of structural units derived from the alkyl (meth)acrylate monomer (mₐ), and
one block B₁ consisting of a chain of structural units derived from the olefinic monomer (m_{b}).

Advantageously, according to this last embodiment, the copolymer is obtained by block polymerization, preferably by controlled block polymerization, optionally followed by one or more post-functionalizations.

Advantageously, according to this last embodiment, the copolymer comprises at least one sequence of blocks AB₁, AB₁A or B₁AB₁ in which said blocks A and B₁ form a chain without the presence of an intermediate block of different chemical nature.

A subject of the invention is also a concentrate for fuel comprising one or more copolymers as described hereinabove and hereinbelow, as a mixture with an organic liquid, said organic liquid being inert with respect to the copolymer(s) and miscible with said fuel.

A subject of the invention is also a fuel composition which comprises:
(1) a fuel derived from one or more sources chosen from the group consisting of mineral, animal, plant and synthetic sources, and
(2) one or more copolymers as described hereinabove and hereinbelow.

According to a preferred embodiment, the fuel composition comprises at least 5 ppm of copolymer(s) (2).

### DETAILED DESCRIPTION

Other advantages and characteristics will emerge more clearly from the description that follows. The particular embodiments of the invention are given as nonlimiting examples.

According to the invention, the copolymer comprises at least one repeating unit comprising an alkyl ester or alkylester function and at least one repeating unit comprising at least one hydrocarbon-based group comprising at least two nitrogen atoms.

The term “alkyl ester” denotes an alkyl carboxylate A1—CO—O—A2with A2 with A2 an alkyl and A1 any group.

The term “alkylester” denotes an alkylcarboxylate A1—CO—O—A2with A1 an alkyl and A₂ any group.

Advantageously, the repeating unit comprising an alkyl ester or alkylester function is an olefinic unit.

Advantageously, the repeating unit comprising at least one hydrocarbon-based group comprising at least two nitrogen atoms is an olefinic unit.

According to a preferred embodiment, the olefinic repeating unit comprising an alkyl ester or alkylester function is chosen from C₆-C₃₄ alkyl esters and C₆-C₃₄ alkylesters.

Advantageously, the olefinic repeating unit comprising an alkyl ester or alkylester function is chosen from:
C₆ to C₃₀, more preferentially C₆ to C₂₄, even more preferentially C₈ to C₂₂ alkyl esters, and
C₆ to C₃₀, more preferentially C₆ to C₂₄, even more preferentially C₈ to C₂₂ alkylesters.

For example, the repeating unit comprising an alkyl ester function may be derived from an alkyl acrylate or alkyl methacrylate monomer. For example, the repeating unit comprising an alkylester function may be derived from a vinyl alkylester or 2-propenyl alkylester monomer.

Preferably, the repeating unit comprising an alkyl ester function is derived from at least one monomer chosen from alkyl acrylate and alkyl methacrylate monomers (mₐ).

For reasons of simplicity, in the rest of the description, the term “alkyl (meth)acrylate” denotes a monomer chosen from alkyl acrylates and alkyl methacrylates.

The monomer (mₐ) is preferably chosen from C₁ to C₃₄, preferably C₄ to C₃₀, more preferentially C₆ to C₂₄ and even more preferentially C₈ to C₂₂ alkyl (meth)acrylates. The alkyl radical of the alkyl acrylate or methacrylate is linear, branched, cyclic or acyclic, preferably acyclic.

Among the alkyl (meth)acrylates that may be used in the manufacture of the copolymer of the invention, mention may be made, in a nonlimiting manner, of: n-octyl acrylate, n-octyl methacrylate, n-decyl acrylate, n-decyl methacrylate, n-dodecyl acrylate, n-dodecyl methacrylate, 2-ethylhexyl acrylate, 2-ethylhexyl methacrylate, isooctyl acrylate, isooctyl methacrylate, isodecyl acrylate, isodecyl methacrylate.

The vinyl alkylester monomers correspond to the formula R′CO—O—CH═CH₂, in which R′ represents a linear, branched, cyclic or acyclic, preferably acyclic, alkyl group.

Preferably, R′ is a linear C₁ to C₃₄, preferably C₄ to C₃₀, more preferentially C₆ to C₂₄ and even more preferentially C₈ to C₂₂ alkyl.

Among the vinyl alkylester monomers, examples that may be mentioned include vinyl octanoate, vinyl decanoate, vinyl dodecanoate, vinyl tetradecanoate, vinyl hexadecanoate, vinyl octadecanoate and vinyl docosanoate.

Preferably, the repeating unit comprising at least one hydrocarbon-based group comprising at least two nitrogen atoms is derived from at least one olefinic monomer (m_{b}) comprising at least one hydrocarbon-based group comprising at least two nitrogen atoms, preferably at least three nitrogen atoms.

Preferably, the olefinic monomer (m_{b}) comprising at least one hydrocarbon-based group comprising at least two nitrogen atoms corresponds to formula (I) below:

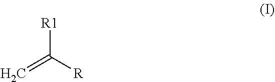

in which:
R represents a linear, branched or cyclic, saturated or unsaturated hydrocarbon-based chain comprising from 1 to 24 carbon atoms, comprising at least two nitrogen atoms, preferably at least three nitrogen atoms, and optionally one or more hydroxyl (OH) substituents and optionally comprising one or more groups chosen from: an ether bridge —O—, an ester bridge —COO—, a carbonyl bridge —CO—,
one or more of the nitrogen atoms may be in the form of a quaternary ammonium,
R₁ represents H or CH₃.

The at least two nitrogen atoms, preferably the at least three nitrogen atoms, may be independently present in the group R in the form of an amine function —NH₂, an amine bridge —NH—, an imine bridge —N═, an amidine bridge —N═C—NH—, a nitrile function —CN, an amide bridge —CONH—, a urea bridge —NH—CO—NH—, a carbamate bridge —O—CO—NH—, a guanidine group, an alkylguanidine, aminoguanidine, biguanidine, polyamine or polyalkylene-polyamine group, or a quaternary ammonium function.

The term “hydrocarbon-based chain” means a chain constituted exclusively of carbon and hydrogen atoms, said chain possibly being linear or branched, cyclic, polycyclic or acyclic, saturated or unsaturated, and optionally aromatic or polyaromatic. A hydrocarbon-based chain may comprise a linear or branched part and a cyclic part. It may comprise an aliphatic part and an aromatic part. The definition of R also includes saturated or unsaturated heterocyclic groups, comprising an alkyl part and at least one function chosen from an ether bridge —O—, an amine bridge —NH—, an imine bridge —N═C, an amidine bridge —N═C—NH—, an amide bridge —CONH—, a urea bridge —NH—CO—NH—, a carbamate bridge —O—CO—NH—, an ester bridge —COO—, a carbonyl bridge —CO—, a guanidine group, an alkylguanidine, aminoguanidine, biguanidine, polyamine or polyalkylene-polyamine group, and a quaternary ammonium group.

Among the quaternary ammonium groups, mention may be made of those obtained by quaternization of primary, secondary or tertiary amines, according to any known process.

At least one of the nitrogen atoms may in particular be in the form of a quaternary ammonium function obtained by quaternization of at least one amine, imine, amidine, guanidine, aminoguanidine or biguanidine function; the heterocyclic groups containing from 3 to 34 atoms and at least one nitrogen atom.

Advantageously, at least one of the nitrogen atoms may in particular be in the form of a group containing at least one quaternary ammonium function obtained by quaternization of a tertiary amine.

According to a particular embodiment, the quaternary ammonium is chosen from iminium, amidinium, formamidinium, guanidinium and biguanidinium quaternary ammoniums.

According to another particular embodiment, at least one nitrogen atom may be in the form of a function containing at least one quaternary ammonium function chosen from heterocyclic groups containing from 3 to 34 atoms and at least one nitrogen atom, preferably from pyrrolinium, pyridinium, imidazolium, triazolium, triazinium, oxazolium and isoxazolium quaternary ammoniums.

According to a particular embodiment, at least one nitrogen atom may in particular be in the form of a function containing at least one quaternary ammonium function, preferably comprising at least one linear or branched, cyclic or acyclic, preferably acyclic, C₁ to C₁₀ and preferably C₁ to C₄ hydrocarbon-based chain, said chain optionally comprising one or more oxygen atoms in the form of an ether function or as a substitution, preferably as a substitution. The hydrocarbon-based chain may be, for example, an alkyl chain substituted with a hydroxyl group, this type of quaternary ammonium possibly being obtained by reaction of a tertiary amine with an epoxide according to any known process.

Advantageously, at least one of the nitrogen atoms is in the form of a trialkylammonium function. The alkyl substituents of the trialkylammonium are preferably chosen from alkyl groups containing from 1 to 10 and preferably from 1 to 4 carbon atoms, and being linear or branched, cyclic or acyclic, preferably acyclic.

According to one variant, at least one of the nitrogen atoms may in particular be in the form of a function chosen from quaternary ammoniums substituted with at least one linear or branched, cyclic or acyclic, preferably acyclic, C₁ to C₁₀ and even more preferentially C₁ to C₄ hydrocarbon-based chain, preferably alkyl, comprising one or more hydroxyl groups.

Preferably, R is chosen from hydrocarbon-based chains comprising from 1 to 24 carbon atoms, comprising at least two nitrogen atoms, preferably at least three nitrogen atoms, and not comprising any oxygen atoms.

According to a first embodiment of the invention, R represents a nitrogenous heterocycle, optionally connected to the olefinic function via an alkyl chain.

According to this variant, the monomer (m_{b}) corresponding to formula (I) is advantageously represented by formula (Ia):

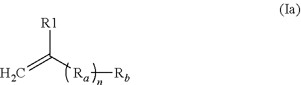

in which:
n represents an integer chosen from 0 and 1,
Ra represents a linear, branched or cyclic C₁-C₁₂ alkyl or C₂-C₁₂ alkenyl chain, optionally comprising one or more ether bridges —O—, an amine bridge —NH—, an imine bridge —N═, a carbonyl bridge —CO—, an ester bridge —COO—, a carboxyl bridge —OCO—, an amide bridge —CONH—, a urea bridge —NH—CO—NH—, a carbamate bridge —O—CO—NH—,
Rb represents a nitrogenous heterocycle comprising at least two nitrogen atoms; advantageously, Rb represents a nitrogenous heterocycle comprising at least three nitrogen atoms,
one or more of the nitrogen atoms of Ra and/or of Rb may be in the form of a quaternary ammonium,
R₁ represents H or CH₃.

According to another variant, the monomer (m_{b}) corresponding to formula (I) is advantageously represented by formula (Ia) in which:
n represents an integer chosen from 0 and 1,
Ra represents a group chosen from one or more ether bridges —O—, an amine bridge —NH—, an imine bridge —N═, a carbonyl bridge —CO—, an ester bridge —COO—, a carboxyl bridge —OCO—, an amide bridge —CONH—, a urea bridge —NH—CO—NH—, a carbamate bridge —O—CO—NH—,
Rb represents a nitrogenous heterocycle comprising at least two nitrogen atoms; advantageously, Rb represents a nitrogenous heterocycle comprising at least three nitrogen atoms,
one or more of the nitrogen atoms of Ra and/or of Rb may be in the form of a quaternary ammonium,
R₁ represents H or CH₃.

Preferably, in formula (Ia), n represents 0.

When n=1, Ra preferably represents a linear or branched C₁-C₈ alkyl chain, optionally comprising a carbonyl bridge.

Rb may be a monocycle or a polycyclic compound.

Preferably, Rb is monocyclic or bicyclic, and even more preferentially Rb is monocyclic.

Rb may be saturated or unsaturated, optionally aromatic.

Preferably, Rb represents a nitrogenous heterocycle comprising at least two nitrogen atoms and at least two carbon atoms. Even more advantageously, Rb represents a nitrogenous heterocycle comprising at least three nitrogen atoms and at least two carbon atoms.

Advantageously, Rb comprises at least five atoms. Even more preferentially, Rb is chosen from rings comprising five atoms and rings comprising six atoms.

Even more advantageously, Rb is chosen from rings comprising five atoms and rings comprising six atoms, these rings comprising two or three nitrogen atoms, and two, three or four carbon atoms.

Among the saturated nitrogenous heterocycles, examples that may be mentioned include the following rings:

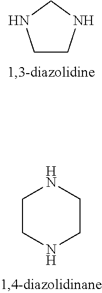 [SMILES: C1CNCN1 ; C1CNCCN1]

Among the unsaturated nitrogenous heterocycles, mention may be made of the following rings:

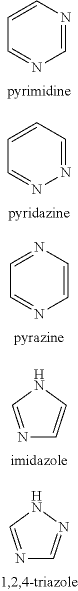 [SMILES: c1cncnc1 ; c1ccnnc1 ; c1cnccn1 ; c1c[nH]cn1 ; c1nc[nH]n1]

As examples of monomers of formula (Ia) in which Rb represents a nitrogenous bicyclic group, mention may be made of 6-amino-9-vinylbenzylpurine (or 9-vinylbenzyladenine), the synthesis of which is described in U.S. Pat. No. 6,870,021, and 9-vinyladenine, the synthesis of which is described in U.S. Pat. No. 3,664,991.

Preferably, Rb comprises at least one unsaturation; better still, Rb comprises at least two unsaturations.

Even more advantageously, Rb is chosen from rings comprising five atoms and rings comprising six atoms chosen from carbon and nitrogen, these rings comprising two or three nitrogen atoms, two, three or four carbon atoms, and at least two unsaturations and the quaternary ammoniums derived therefrom by quaternization of a nitrogen atom.

Very advantageously, according to this variant, the monomer m_{b} is chosen from:

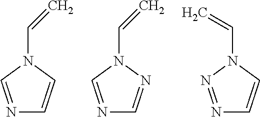

N-vinylimidazole, 1-vinyl-1,2,4-triazole and 1-vinyl-1,2,3-triazole and the quaternary ammoniums derived therefrom by quaternization of a nitrogen atom.

Advantageously, the monomer m_{b} is chosen from 1-vinyl-1,2,4-triazole and 1-vinyl-1,2,3-triazole; preferably, the monomer m_{b} is 1-vinyl-1,2,4-triazole and the quaternary ammoniums derived therefrom by quaternization of a nitrogen atom.

According to a second embodiment of the invention, R represents a linear, branched or cyclic nitrogenous hydrocarbon-based chain. Preferably, according to this variant, the at least two nitrogen atoms, preferably the at least three nitrogen atoms, form part of a function chosen from: a guanidine, alkylguanidine, aminoguanidine or biguanidine function, an amidine function, a polyamine or polyalkylene-polyamine chain and the quaternary ammoniums derived therefrom by quaternization of a nitrogen atom.

According to this variant, the monomer (m_{b}) corresponding to formula (I) is advantageously represented by formula (Ib):

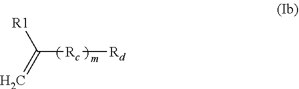

in which:
m represents an integer chosen from 0 and 1,
Rc represents a linear, branched or cyclic C₁-C₁₂ alkyl or C₂-C₁₂ alkenyl chain, optionally comprising one or more groups chosen from: an ether bridge —O—, an amine bridge —NH—, an imine bridge —N═, an ester bridge —COO—, a carbonyl bridge —CO—, an amide bridge —CONH—, a urea bridge —NH—CO—NH—, a carbamate bridge —O—CO—NH—,
Rd represents a group chosen from amidine, guanidine, alkylguanidine, aminoguanidine, biguanidine, polyamine and polyalkylene-polyamine groups, one or more of the nitrogen atoms of Rc and/or of Rd may be in the form of a quaternary ammonium,
R1 represents H or CH₃.

According to another variant, the monomer (m_{b}) corresponding to formula (I) is advantageously represented by formula (Ib) in which:
m represents an integer chosen from 0 and 1,
Rc represents a linear, branched or cyclic C₁-C₁₂ alkyl or C₂-C₁₂ alkenyl chain, optionally comprising one or more groups chosen from: an ether bridge —O—, an amine bridge —NH—, an imine bridge —N═, an ester bridge —COO—, a carbonyl bridge —CO—, an amide bridge —CONH—, a urea bridge —NH—CO—NH—, a carbamate bridge —O—CO—NH—,
Rd represents a group chosen from amidine, guanidine, alkylguanidine, aminoguanidine, biguanidine, polyamine and polyalkylene-polyamine groups, one or more of the nitrogen atoms of Rc and/or of Rd may be in the form of a quaternary ammonium,
R1 represents H or CH₃.

Preferably, according to this variant, Rc represents a linear or branched C₁-C₈ alkyl chain.

Among the groups Rd, mention may be made especially of:
amidine: —(C═NH)—NH₂; —(C═NH)—NR′H; —(C═NH)—NR′R″; —(C═NR′)—NH₂; —(C═NR′)—NR″H; —(C═NR′)—NR″R′″; —N═CH(NH₂); —N═CR′(NH₂); —N═CH(NR′H); —N═CR′(NR′H); —N═CH(NR′R″); —N═CR′(NR″R′″);
guanidine: —NH—(C═NH)—NH₂; —NH—(C═NH)—NHR′; —N═C(NH₂)₂; —N═C(NR′H)₂;—N═C(NR′R″)₂; —N═C(NR′H)(NR″H);
aminoguanidine: —NH—(C═NH)—NH—NH₂; —NH—(C═NH)—NH—NHR′; —N═C(NH₂)(NH—NH₂); —N═C(NR′H)(NH—NH₂); —N═C(NR′H)(NR′—NH₂); —N═C(NR′R″)(NH—NH₂); —N═C(NR′R″) (NR′—NH₂);
biguanidine: —NH—(C═NH)—NH—(C═NH)—NH₂; —NH—(C═NH)—NH—(C═NH)—NHR′; —N═C(NH₂)—NH—(C═NH)—NH₂; —N═C(NH₂)—NH—(C═NR′)—NH₂; —N═C(NH₂)—NH—(C═NH)—NR′H; —N═C(NH₂)—NH—(C═NR′)—NR″H; —N═C(NH₂)—NH—(C═NH)—NR′R″; —N═C(NH₂)—NH—(C═NR′)—NR″R′″; —N═C(NR′H)—NH—(C═NH)—NH₂; —N═C(NR′H)—NH—(C═NR″)—NH₂; —N═C(NR′H)—NH—(C═NH)—NR″H; —N═C(NR′H)—NH—(C═NR″)—NR′″H; —N═C(NR′H)—NH—(C═NH)—NR″R′″; —N═C(NR′H)—NH—(C═NR″)—NR′″R″″; —N═C(NR′R″)—NH—(C═NH)—NH₂; —N═C(NR′R″)—NH—(C═NR′″)—NH₂; —N═C(NR′R″)—NH—(C═NH)—NR′″H; —N═C(NR′R″)—NH—(C═NR″′)—NR″″H; —N═C(NR′R″)—NH—(C═NH)—NR′″R″″; —N═C(NR′R″)—NH—(C═NR′″)—NR″″R′″″;
the groups —NH—(R_{J}—NH)ₖ—H; —NH—(R_{J}—NH)ₖ—R′; and
groups derived therefrom by quaternization of one or more of the nitrogen atoms of these groups;
R′, R″, R′″, R″″ and R′″″ represent, independently of each other, a C₁-C₃₆ and preferably C₁-C₁₂ alkyl group, optionally comprising one or more NH₂ functions and one or —NH— bridges;
Rⱼ represents a C₁-C₆ and preferably C₂-C₄ alkane diyl group;
k represents an integer ranging from 1 to 20 and preferably from 2 to 12.

Examples of groups Rd chosen from polyamines and polyalkylene-polyamines that may be mentioned include: ethylenediamine, diethylenetriamine, triethylenetetramine and tetraethylenepentamine.

Very advantageously, according to this variant, the monomer m_{b} is: 1-(phenylmethyl)-1-vinylguanidine.

The copolymer may be prepared according to any known polymerization process. The various polymerization techniques and conditions are widely described in the literature and fall within the general knowledge of a person skilled in the art.

It is understood that it would not constitute a departure from the scope of the invention if the copolymer according to the invention were obtained from monomers other than mₐ and m_{b}, provided that the final copolymer corresponds to that of the invention, i.e. a polymer obtained by copolymerization of at least (mₐ) and (m_{b}). For example, it would not constitute a departure from the scope of the invention if the copolymer were obtained by copolymerization of monomers other than (mₐ) and (m_{b}) followed by post-functionalization.

For example, the units derived from an alkyl (meth)acrylate monomer (mₐ) may be obtained from a polymethyl (meth)acrylate fragment, by transesterification reaction using an alcohol of chosen chain length to form the expected alkyl group.

For example, the repeating unit comprising a group containing at least two nitrogen atoms, preferably at least three nitrogen atoms, may be obtained from a polyvinyl fragment functionalized with a precursor group, for example by reaction of a substituted or unsubstituted guanidine with chloromethyl polystyrene divinylbenzene as described in U.S. Pat. No. 5,028,259 or by reaction of chloroformamidinium chloride with aminomethyl polystyrene divinylbenzene as described in U.S. Pat. No. 5,726,253. Such conversion reactions are well known to those skilled in the art.

The copolymer may be a statistical copolymer or a block copolymer.

Preferably, the copolymer is a block copolymer.

Preferably, the copolymer is a block copolymer comprising at least:
one block A consisting of a chain of repeating units comprising an alkyl ester function,
   and
one block B consisting of a chain of repeating units comprising at least two nitrogen atoms, preferably at least three nitrogen atoms.

Preferably, the copolymer is a block copolymer comprising at least:
one block A consisting of a chain of structural units derived from the monomer (mₐ),
   and
one block B consisting of a chain of structural units derived from the monomer (m_{b}).

According to a particular embodiment, the block copolymer is obtained by copolymerization of at least the alkyl (meth)acrylate monomer (mₐ) and of at least the monomer comprising at least two nitrogen atoms, preferably at least three nitrogen atoms, (m_{b}).

The block copolymer may be obtained by block polymerization, preferably by controlled block polymerization, optionally followed by one or more post-functionalizations.

According to a particular embodiment, the block copolymer described above is obtained by controlled block polymerization. The polymerization is advantageously chosen from controlled radical polymerization; for example atom transfer radical polymerization (ATRP); nitroxide-mediated radical polymerization (NMP: nitroxide-mediated polymerization); degenerative transfer processes such as degenerative iodine transfer polymerization (ITRP: iodine transfer radical polymerization) or reversible addition-fragmentation chain transfer radical polymerization (RAFT: reversible addition-fragmentation chain transfer); polymerizations derived from ATRP such as polymerizations using initiators for continuous activator regeneration (ICAR) or using activators regenerated by electron transfer (ARGET).

Mention will be made, by way of example, of the publication “Macromolecular engineering by atom transfer radical polymerization” JACS, 136, 6513-6533 (2014), which describes a controlled block polymerization process for forming block copolymers.

The controlled block polymerization is typically performed in a solvent, under an inert atmosphere, at a reaction temperature generally ranging from 0 to 200° C., preferably from 50° C. to 130° C. The solvent may be chosen from polar solvents, in particular ethers such as anisole (methoxybenzene) or tetrahydrofuran, or apolar solvents, in particular paraffins, cycloparaffins, aromatic and alkylaromatic solvents containing from 1 to 19 carbon atoms, for example benzene, toluene, cyclohexane, methylcyclohexane, n-butene, n-hexane, n-heptane and the like.

For atom-transfer radical polymerization (ATRP), the reaction is generally performed under vacuum in the presence of an initiator, a ligand and a catalyst. As examples of ligands, mention may be made of N,N,N′,N″,N″-pentamethyldiethylenetriamine (PMDETA), 1,1,4,7,10,10-hexamethyltriethylenetetramine (HMTETA), 2,2′-bipyridine (BPY) and tris(2-pyridylmethyl)amine (TPMA). Examples of catalysts that may be mentioned include: CuX, CuX₂, with X═Cl, Br and the ruthenium-based complexes Ru²⁺/Ru³⁺.

The ATRP polymerization is preferably performed in a solvent chosen from polar solvents.

According to the controlled block polymerization technique, it may also be envisaged to work under pressure.

According to a particular embodiment, the number of equivalents of monomer mₐ in block A and of monomer m_{b} in block B reacted during the polymerization reaction are identical or different and independently range from 2 to 40, preferably from 3 to 30, more preferentially from 4 to 20 and even more preferentially from 5 to 10. The term “number of equivalents” means the ratio between the amounts (in moles) of material of the monomers (mₐ) of block A and of the monomers (m_{b}) of block B, used during the polymerization reaction.

The number of equivalents of monomer mₐ in block A is advantageously greater than or equal to the number of equivalents of the monomer m_{b} in block B. In addition, the weight-average molar mass M_{w} of block A or of block B is preferably less than or equal to 15 000 g.mol.⁻¹, more preferentially less than or equal to 10 000 g.mol.⁻¹.

The block copolymer advantageously comprises at least one sequence of blocks AB, ABA or BAB in which said blocks A and B form a chain without the presence of an intermediate block of different chemical nature.

Other blocks may optionally be present in the block copolymer described previously provided that these blocks do not fundamentally change the nature of the block copolymer. Block copolymers solely containing blocks A and B will, nevertheless, be preferred.

Preferably, the blocks A and B represent at least 70% by mass of the total mass of monomers used in the polymerization reaction, preferably at least 90% by mass, advantageously at least 95% by mass and better still at least 99% by mass.

According to a particular embodiment, the block copolymer is a diblock copolymer.

According to another particular embodiment, the block copolymer is a triblock copolymer with alternating blocks comprising two blocks A and one block B (ABA) or comprising two blocks B and one block A (BAB).

According to a particular embodiment, the block copolymer also comprises an end chain I consisting of a saturated or unsaturated, linear, branched or cyclic C₁ to C₃₂, preferably C₄ to C₂₄, and more preferentially C₁₀ to C₂₄ hydrocarbon-based chain.

The term “cyclic hydrocarbon-based chain” means a hydrocarbon-based chain of which at least part is cyclic, especially aromatic. This definition does not exclude hydrocarbon-based chains comprising both an acyclic part and a cyclic part.

The end chain I may comprise an aromatic hydrocarbon-based chain, for example benzene-based, and/or a saturated and acyclic, linear or branched hydrocarbon-based chain, in particular an alkyl chain.

The end chain I is preferably chosen from alkyl chains, which are preferably linear, more preferentially alkyl chains of at least 4 carbon atoms and even more preferentially of at least 12 carbon atoms.

For the ATRP polymerization, the end chain I is located in the end position of the block copolymer. It may be introduced into the block copolymer by means of the polymerization initiator. Thus, the end chain I may advantageously constitute at least part of the polymerization initiator and is positioned in the polymerization initiator so as to allow the introduction, during the first step of polymerization initiation, of the end chain I in the end position of the block copolymer.

The polymerization initiator is chosen, for example, from the free-radical initiators used in the ATRP polymerization process. These free-radical initiators well known to those skilled in the art are described especially in the article “Atom-transfer radical polymerization: current status and future perspectives, Macromolecules, 45, 4015-4039, 2012”.

The polymerization initiator is chosen, for example, from alkyl esters of a carboxylic acid substituted with a halide, preferably a bromine in the alpha position, for example ethyl 2-bromopropionate, ethyl α-bromoisobutyrate, benzyl chloride or bromide, ethyl α-bromophenylacetate and chloroethylbenzene. Thus, for example, ethyl 2-bromopropionate may allow the introduction into the copolymer of the end chain I in the form of a C₂ alkyl chain and of benzyl bromide in the form of a benzyl group.

For the RAFT polymerization, the transfer agent may conventionally be removed from the copolymer at the end of polymerization according to any known process.

According to a particular embodiment, the end chain I may be obtained via the methods described in the article by Moad, G. et al., Australian Journal of Chemistry, 2012, 65, 985-1076. For example, the end chain I may be introduced by aminolysis when a transfer agent is used. Examples that may be mentioned include transfer agents of thiocarbonylthio, dithiocarbonate, xanthate, dithiocarbamate and trithiocarbonate type, for example S,S-bis(α,α′-dimethyl-α″-acetic acid) trithiocarbonate (BDMAT) or 2-cyano-2-propyl benzodithioate.

According to a particular embodiment, the block copolymer is a diblock copolymer. The block copolymer structure may be of the IAB or IBA type, advantageously of the IAB type. The end chain I may be connected directly to block A or B as the structure IAB or IBA, respectively, or may be connected via a bonding group, for example an ester, amide, amine or ether function. The bonding group then forms a bridge between the end chain I and block A or B.

According to a particular embodiment, the block copolymer may also be functionalized at the chain end according to any known process, especially by hydrolysis, aminolysis and/or nucleophilic substitution.

The term “aminolysis” means any chemical reaction in which a molecule is split into two parts by reaction of an ammonia molecule or an amine. A general example of aminolysis consists in replacing a halogen of an alkyl group by reaction with an amine, with removal of hydrogen halide. Aminolysis may be used, for example, for an ATRP polymerization which produces a copolymer bearing a halide in the end position or for a RAFT polymerization to remove the thio, dithio or trithio bond introduced into the copolymer by the RAFT transfer agent.

It is thus possible to introduce an end chain I′ by post-functionalization of the block copolymer obtained by controlled block polymerization of the monomers mₐ and m_{b} described above.

The end chain I′ advantageously comprises a linear, branched or cyclic C₁ to C₃₂, preferably C₁ to C₂₄ and more preferentially C₁ to C₁₀ hydrocarbon-based chain, even more preferentially an alkyl group, optionally substituted with one or more groups containing at least one heteroatom chosen from N and 0, preferably N.

For an ATRP polymerization using a metal halide as catalyst, this functionalization may be performed, for example, by treating the copolymer IAB or IBA obtained by ATRP with a primary C₁ to C₃₂ alkylamine or a C₁ to C₃₂ alcohol under mild conditions so as not to modify the functions present on the blocks A, B and I.

According to a preferred embodiment, the monomer m_{b} is chosen from 1-vinyltriazole (1-ethenyl-1,2,3-triazole), 1-vinyl-1,2,4-triazole, vinylbenzotriazole, vinyladenine, vinyltriazine, 2,4-dimethyl-6-vinyltriazine and 2-vinyl-4,6-diamino-1,3,5-triazine (CAS 3194-70-5).

According to a preferred embodiment, the block copolymer is as described above and block B is a block B₁ consisting of a chain of structural units derived from at least one monomer chosen from: 1-vinyltriazole, 1-vinyl-1,2,4-triazole, vinylbenzotriazole, vinyladenine, vinyltriazine, 2,4-dimethyl-6-vinyltriazine, 2-vinyl-4,6-diamino-1,3,5-triazine (CAS 3194-70-5).

The block copolymer in particular comprises at least one sequence of blocks AB₁, AB₁A or B₁AB₁ in which blocks A and B₁ form a chain without the presence of an intermediate block of different chemical nature.

The block copolymer in particular comprises at least one sequence of blocks AB₁, AB₁A or B₁AB₁ in which blocks A and B₁ form a chain without the presence of an intermediate block of different chemical nature.

According to a preferred particular embodiment, the block copolymer is represented by formula (IIa) or formula (IIb) below:

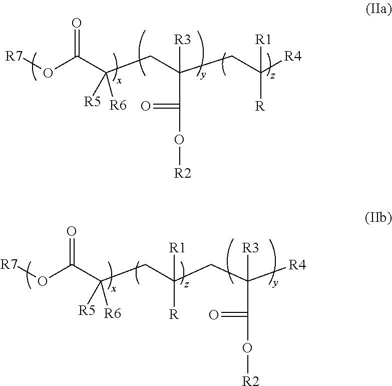

in which:
R and R1 are as defined above in formula (I),
x=0 or 1,
y is an integer ranging from 2 to 40, preferably from 3 to 30, more preferentially from 4 to 20, even more preferentially from 5 to 10,
z is an integer ranging from 2 to 40, preferably from 3 to 30, more preferentially from 4 to 20, even more preferentially from 5 to 10,
R₂ is chosen from linear, branched or cyclic, preferably acyclic, C₆ to C₃₄, preferably C₆ to C₃₀, more preferentially C₆ to C₂₄ and even more preferentially C₈ to C₂₂ alkyl groups,
R₃ is chosen from hydrogen and a methyl group,
R₄ is chosen from the group constituted by:
hydrogen;
OH;
halogens, preferably bromine; and
linear, branched or cyclic, saturated or unsaturated C₁ to C₃₂, preferably C₁ to C₂₄ and more preferentially C₁ to C₁₀ hydrocarbon-based chains, preferably alkyl groups, said hydrocarbon-based chains being optionally substituted with one or more groups containing at least one heteroatom chosen from N and 0,
R₅ and R₆ are identical or different and chosen independently from the group constituted by hydrogen and linear or branched C₁ to C₁₀ and preferably C₁ to C₄ alkyl groups, even more preferentially a methyl group,
R₇ is chosen from hydrocarbon-based chains, preferably cyclic or acyclic, saturated or unsaturated, linear or branched C₁ to C₃₂, preferably C₄ to C₂₄ and more preferentially C₁₀ to C₂₄ alkyl groups, and groups derived from a reversible addition-fragmentation chain-transfer (RAFT) radical polymerization transfer agent, it being understood that if R₇ is a group derived from a transfer agent, then x=0.

Transfer agents of RAFT type are well known to those skilled in the art. A wide diversity of RAFT-type transfer agents are available or are quite readily synthesizable. Examples that may be mentioned include transfer agents of thiocarbonylthio, dithiocarbonate, xanthate, dithiocarbamate and trithiocarbonate type, for example S,S-bis(β,β′-dimethyl-β″-acetic acid) trithiocarbonate (BDMAT) or 2-cyano-2-propyl benzodithioate.

A synthesis of block copolymer using a RAFT agent is described, for example, in the article by Zhishen Ge et al. entitled “Stimuli-Responsive Double Hydrophilic Block Copolymer Micelles with Switchable Catalytic Activity”, Macromolecules 2007, 40, 3538-3546. This article describes in particular, on pages 3540 and 3541, the synthesis of a block polymer by RAFT/MADIX polymerization. This article is cited as an example of synthesis of block copolymers and/or incorporated by reference, in particular pages 3540 and 3541.

Advantageously, R is chosen from the groups:

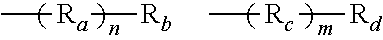

in which Ra, Rb and n are as defined above for formula (Ia),
and
in which Rc, Rd and m are as defined above for formula (Ib).

In formulae (IIa) and (IIb), block A corresponds to the unit repeated y times and block B to the unit repeated z times. In addition, the group R7 may be constituted of the end chain I as described above and/or the group R4 may be constituted of the end chain I′ as described above.

The copolymer described above is particularly advantageous when it is used, alone or as a mixture, as detergent additive in a liquid fuel for an internal combustion engine.

In particular, the block copolymer described above has noteworthy properties as detergent additive in a liquid fuel for an internal combustion engine.

The term “detergent additive for a liquid fuel” means an additive which is incorporated in small amount into the liquid fuel and produces an effect on the cleanliness of said engine when compared with said liquid fuel not specially supplemented with additive.

The liquid fuel is advantageously derived from one or more sources chosen from the group consisting of mineral, animal, plant and synthetic sources. Crude oil will preferably be chosen as mineral source.

The liquid fuel is preferably chosen from hydrocarbon-based fuels and fuels that are not essentially hydrocarbon-based, alone or as a mixture.

The hydrocarbon-based fuels especially comprise middle distillates with a boiling point of between 100 and 500° C. or lighter distillates with a boiling point in the gasoline range. These distillates may be chosen, for example, from the distillates obtained by direct distillation of crude hydrocarbons, vacuum distillates, hydrotreated distillates, distillates derived from the catalytic cracking and/or hydrocracking of vacuum distillates, distillates resulting from conversion processes such as ARDS (atmospheric residue desulfurization) and/or viscoreduction, and distillates derived from the upgrading of Fischer-Tropsch fractions. The hydrocarbon-based fuels are typically gasolines and gas oils (also known as diesel fuel).

Gasolines in particular comprise any commercially available fuel composition for a gasoline engine. Representative examples that may be mentioned are the gasolines corresponding to standard NF EN 228. Gasolines generally have octane numbers that are high enough to avoid pinking. Typically, the fuels of gasoline type sold in Europe, in accordance with standard NF EN 228, have a motor octane number (MON) of greater than 85 and a research octane number (RON) of at least 95. Fuels of gasoline type generally have an RON of between 90 and 100 and an MON of between 80 and 90, the RON and MON being measured according to standard ASTM D 2699-86 or D 2700-86.

Gas oils (diesel fuels) in particular comprise any commercially available fuel composition for diesel engines. Representative examples that may be mentioned are the gas oils corresponding to standard NF EN 590.

Fuels that are not essentially hydrocarbon-based especially comprise oxygenated fuels, for example distillates resulting from BTL (biomass-to-liquid) conversion of plant and/or animal biomass, taken alone or in combination; biofuels, for example plant and/or animal oils and/or esters of plant and/or animal oils; biodiesels of animal and/or plant origin and bioethanols.

The mixtures of hydrocarbon-based fuel and of fuel that is not essentially hydrocarbon-based are typically gas oils of Bₓ type or gasolines of Eₓ type.

The term “gas oil of Bₓ type for diesel engines” means a gas oil fuel which contains x % (v/v) of plant or animal ester oils (including spent cooking oils) transformed via a chemical process known as transesterification, obtained by reacting this oil with an alcohol so as to obtain fatty acid esters (FAE). With methanol and ethanol, fatty acid methyl esters (FAME) and fatty acid ethyl esters (FAEE) are obtained, respectively. The letter “B” followed by a number indicates the percentage of FAE contained in the gas oil. Thus, a B99 contains 99% of FAE and 1% of middle distillates of fossil origin (mineral source), B20 contains 20% of FAE and 80% of middle distillates of fossil origin, etc. Gas oils of B₀ type which do not contain any oxygen-based compounds are thus distinguished from gas oils of Bx type which contain x % (v/v) of plant oil esters or of fatty acid esters, usually methyl esters (POME or FAME). When the FAE is used alone in engines, the fuel is designated by the term B100.

The term “gasoline of Eₓ type for gasoline engines” means a gasoline fuel which contains x % (v/v) of oxygen-based compounds, generally ethanol, bioethanol and/or tert-butyl ethyl ether (TBEE).

The sulfur content of the liquid fuel is preferably less than or equal to 5000 ppm, preferably less than or equal to 500 ppm and more preferentially less than or equal to 50 ppm, or even less than or equal to 10 ppm and advantageously sulfur-free.

The copolymer described above is used as detergent additive in the liquid fuel in a content advantageously of at least 10 ppm, preferably at least 50 ppm, more preferentially in a content ranging from 10 to 5000 ppm, even more preferentially from 10 to 1000 ppm.

According to a particular embodiment, the use of a copolymer as described previously in the liquid fuel makes it possible to maintain the cleanliness of at least one of the internal parts of the internal combustion engine and/or to clean at least one of the internal parts of the internal combustion engine.

The use of the copolymer in the liquid fuel makes it possible in particular to limit or prevent the formation of deposits in at least one of the internal parts of said engine (“keep-clean” effect) and/or to reduce the existing deposits in at least one of the internal parts of said engine (“clean-up” effect).

Thus, the use of the copolymer in the liquid fuel makes it possible, when compared with liquid fuel that is not specially supplemented, to limit or prevent the formation of deposits in at least one of the internal parts of said engine or to reduce the existing deposits in at least one of the internal parts of said engine.

Advantageously, the use of the copolymer in the liquid fuel makes it possible to observe both effects simultaneously, limitation (or prevention) and reduction of deposits (“keep-clean” and “clean-up” effects).

The deposits are distinguished as a function of the type of internal combustion engine and of the location of the deposits in the internal parts of said engine.

According to a particular embodiment, the internal combustion engine is a spark ignition engine, preferably with direct injection (DISI: direct-injection spark ignition engine). The deposits targeted are located in at least one of the internal parts of said spark ignition engine. The internal part of the spark ignition engine kept clean and/or cleaned up is advantageously chosen from the engine intake system, in particular the intake valves (IVD: intake valve deposit), the combustion chamber (CCD: combustion chamber deposit, or TCD: total chamber deposit) and the fuel injection system, in particular the injectors of an indirect injection system (PFI: port fuel injector) or the injectors of a direct injection system (DISI).

According to another particular embodiment, the internal combustion engine is a diesel engine, preferably a direct-injection diesel engine, in particular a diesel engine with a common-rail injection system (CRDI: common-rail direct injection). The deposits targeted are located in at least one of the internal parts of said diesel engine.

Advantageously, the deposits targeted are located in the injection system of the diesel engine, preferably located on an external part of an injector of said injection system, for example the fuel spray tip and/or on an internal part of an injector of said injection system (IDID: internal diesel injector deposits), for example on the surface of an injector needle.

The deposits may be constituted of coking-related deposits and/or deposits of soap and/or lacquering type.

The copolymer as described previously may advantageously be used in the liquid fuel to reduce and/or prevent and/or avoid power loss due to the formation of deposits in the internal parts of a direct-injection diesel engine, said power loss being determined according to the standardized engine test method CEC F-98-08.

The copolymer as described previously may advantageously be used in the liquid fuel to reduce and/or prevent and/or avoid restriction of the fuel flow emitted by the injector of a direct-injection diesel engine during its functioning, said flow restriction being determined according to the standardized engine test method CEC F-23-1-01.

The use of the copolymer as described above advantageously makes it possible to limit or prevent the formation of deposits in at least one of the internal parts of said engine or to reduce the existing deposits in at least one of the internal parts of said engine, on at least one type of deposit described previously.

According to a particular embodiment, the use of the copolymer described above also makes it possible to reduce the fuel consumption of an internal combustion engine.

According to another particular embodiment, the use of the copolymer described above also makes it possible to reduce the pollutant emissions, in particular the particle emissions of an internal combustion engine.

Advantageously, the use of the copolymer makes it possible to reduce both the fuel consumption and the pollutant emissions.

The copolymer described above may be used alone, in the form of a mixture of at least two of said copolymers or in the form of a concentrate.

The copolymer may be added to the liquid fuel in a refinery and/or may be incorporated downstream of the refinery and/or optionally as a mixture with other additives in the form of an additive concentrate, also known by the common name “additive package”.

The copolymer described above may be used as a mixture with an organic liquid in the form of a concentrate.

According to a particular embodiment, a concentrate for fuel comprises one or more copolymers as described above, as a mixture with an organic liquid.

The organic liquid is inert with respect to the copolymer described above and miscible in the liquid fuel described previously. The term “miscible” describes the fact that the copolymer and the organic liquid form a solution or a dispersion so as to facilitate the mixing of the copolymer in the liquid fuels according to the standard fuel supplementation processes.

For the purposes of the present invention, the term “miscible” means that the organic liquid and the liquid fuel form a solution when they are mixed, in all proportions, at room temperature.

The organic liquid is advantageously chosen from aromatic hydrocarbon-based solvents such as the solvent sold under the name Solvesso, alcohols, ethers and other oxygen-based compounds and paraffinic solvents such as hexane, pentane or isoparaffins, alone or as a mixture.

The concentrate may advantageously comprise from 5% to 99% by mass, preferably from 10% to 80% and more preferentially from 25% to 70% of copolymer(s) as described previously.

The concentrate may typically comprise from 1% to 95% by mass, preferably from 10% to 70% and more preferentially from 25% to 60% of organic liquid, the remainder corresponding to the copolymer defined previously, it being understood that the concentrate may comprise one or more copolymers as described above.

In general, the solubility of the copolymer in the organic liquids and the liquid fuels described previously will depend especially on the weight-average and number-average molar masses M_{w} and Mₙ, respectively, of the copolymer. The average molar masses M_{w} and Mₙ of the copolymer will be chosen so that the copolymer is soluble in the liquid fuel and/or the organic liquid of the concentrate for which it is intended.

The average molar masses M_{w} and Mₙ of the copolymer may also have an influence on the efficacy of this copolymer as a detergent additive. The average molar masses M_{w} and Mₙ will thus be chosen so as to optimize the effect of the copolymer, especially the detergent effect (engine cleanliness) in the liquid fuels described above.

Optimizing the average molar masses M_{w} and Mₙ may be performed via routine tests accessible to those skilled in the art.

According to a particular embodiment, the copolymer advantageously has a weight-average molar mass M_{w} ranging from 500 to 30 000 g.mol⁻¹, preferably from 1000 to 10 000 g.mol⁻¹, more preferentially less than or equal to 4000 g.mol⁻¹, and/or a number-average molar mass Mₙ ranging from 500 to 15 000 g.mol⁻¹, preferably from 1000 to 10 000 g.mol⁻¹, more preferentially less than or equal to 4000 g.mol⁻¹. The number-average and weight-average molar masses are measured by size exclusion chromatography (SEC). The operating conditions of SEC, especially the choice of the solvent, will be chosen as a function of the chemical functions present in the copolymer.

According to a particular embodiment, the copolymer is used in the form of an additive concentrate in combination with at least one other fuel additive for an internal combustion engine other than the copolymer described previously.

The additive concentrate may typically comprise one or more other additives chosen from detergent additives other than the copolymer described above, for example from anticorrosion agents, dispersants, de-emulsifiers, antifoams, biocides, reodorants, proketane additives, friction modifiers, lubricant additives or oiliness additives, combustion promoters (catalytic combustion and soot promoters), agents for improving the cloud point, the flow point or the FLT (filterability limit temperature), anti-sedimentation agents, anti-wear agents and conductivity modifiers.

Among these additives, mention may be made in particular of:
a) proketane additives, especially (but not limitingly) chosen from alkyl nitrates, preferably 2-ethylhexyl nitrate, aryl peroxides, preferably benzyl peroxide, and alkyl peroxides, preferably tert-butyl peroxide;
b) antifoam additives, especially (but not limitingly) chosen from polysiloxanes, oxyalkylated polysiloxanes and fatty acid amides derived from plants or animal oils. Examples of such additives are given in EP 861 882, EP 663 000 and EP 736 590;
c) CFI (Cold Flow Improver) additives chosen from copolymers of ethylene and of unsaturated ester, such as ethylene/vinyl acetate (EVA), ethylene/vinyl propionate (EVP), ethylene/vinyl ethanoate (EVE), ethylene/methyl methacrylate (EMMA) and ethylene/alkyl fumarate copolymers described, for example, in U.S. Pat. No. 3,048,479, U.S. Pat. No. 3,627,838, U.S. Pat. No. 3,790,359, U.S. Pat. No. 3,961,961 and EP 261 957;
d) lubricant additives or anti-wear agents, especially (but not limitingly) chosen from the group constituted by fatty acids and ester or amide derivatives thereof, especially glyceryl monooleate, and monocyclic and polycyclic carboxylic acid derivatives. Examples of such additives are given in the following documents: EP 680 506, EP 860 494, WO 98/04656, EP 915 944, FR 2 772 783, FR 2 772 784;
e) cloud point additives, especially (but not limitingly) chosen from the group constituted by long-chain olefin/(meth)acrylic ester/maleimide terpolymers, and fumaric/maleic acid ester polymers. Examples of such additives are given in FR 2 528 051, FR 2 528 051, FR2 528 423, EP 112 195, EP 172 758, EP 271 385 and EP 291 367;
f) detergent additives, especially (but not limitingly) chosen from the group constituted by succinimides, polyetheramines and quaternary ammonium salts; for example those described in U.S. Pat. No. 4,171,959 and WO 2006/135 881;
g) cold workability polyfunctional additives chosen from the group constituted by polymers based on olefin and alkenyl nitrate as described in EP 573 490.

These other additives are generally added in an amount ranging from 100 ppm to 1000 ppm (each).

The mole ratio and/or mass ratio between monomer m_{b} and monomer mₐ and/or between block A and B or B₁ in the copolymer described above will be chosen so that the block copolymer is soluble in the fuel and/or the organic liquid of the concentrate for which it is intended. Similarly, this ratio may be optimized as a function of the fuel and/or of the organic liquid so as to obtain the best effect on the engine cleanliness.

Optimizing the mole ratio and/or mass ratio may be performed via routine tests accessible to those skilled in the art.

The mole ratio between monomer m_{b} and monomer mₐ or between blocks A and B or B₁ in the copolymer described above is advantageously from 1:10 to 10:1, preferably from 1:2 to 2:1 and more preferentially from 1:0.5 to 0.5:2.

According to a particular embodiment, a fuel composition is prepared according to any known process by supplementing the liquid fuel described previously with at least one copolymer as described above.

According to a particular embodiment, the fuel composition comprises:
(1) a fuel as described above, and
(2) one or more copolymers as described previously.

The fuel (1) is chosen in particular from hydrocarbon-based fuels and fuels that are not essentially hydrocarbon-based described previously, alone or as a mixture.

The combustion of this fuel composition comprising such a copolymer in an internal combustion engine produces an effect on the cleanliness of the engine when compared with the liquid fuel not specially supplemented and makes it possible in particular to prevent or reduce the fouling of the internal parts of said engine. The effect on the cleanliness of the engine is as described previously in the context of using the copolymer.

According to a particular embodiment, combustion of the fuel composition comprising such a copolymer in an internal combustion engine also makes it possible to reduce the fuel consumption and/or the pollutant emissions.

The copolymer (2) is preferably incorporated in small amount into the liquid fuel described previously, the amount of copolymer being sufficient to produce a detergent effect as described above and thus to improve the engine cleanliness.

The fuel composition advantageously comprises at least 10 ppm, preferably at least 50 ppm, more preferentially from 10 to 5000 ppm and in particular from 10 to 1000 ppm of copolymer(s) (2).

Besides the copolymer described above, the fuel composition may also comprise one or more other additives other than the copolymer according to the invention, chosen from the other known detergent additives, for example from anticorrosion agents, dispersants, de-emulsifiers, antifoams, biocides, reodorants, proketane additives, friction modifiers, lubricant additives or oiliness additives, combustion promoters (catalytic combustion and soot promoters), agents for improving the cloud point, the flow point or the FLT, anti-sedimentation agents, anti-wear agents and/or conductivity modifiers.

The various additives of the copolymer according to the invention are, for example, the fuel additives listed above.

According to a particular embodiment, a process for keeping clean (keep-clean) and/or for cleaning (clean-up) at least one of the internal parts of an internal combustion engine comprises at least the following steps:

the preparation of a fuel composition by supplementation of a fuel with one or more copolymers as described above, and

the combustion of said fuel composition in the internal combustion engine.

According to a particular embodiment, the internal combustion engine is a spark ignition engine, preferably with direct injection (DISI).

The internal part of the spark ignition engine that is kept clean and/or cleaned is preferably chosen from the engine intake system, in particular the intake valves (IVD), the combustion chamber (CCD or TCD) and the fuel injection system, in particular the injectors of an indirect injection system (PFI) or the injectors of a direct injection system (DISI).

According to another particular embodiment, the internal combustion engine is a diesel engine, preferably a direct-injection diesel engine, in particular a diesel engine with a common-rail injection system (CRDI).

The internal part of the diesel engine that is kept clean (keep-clean) and/or cleaned (clean-up) is preferably the injection system of the diesel engine, preferably an external part of an injector of said injection system, for example the fuel spray tip and/or one of the internal parts of an injector of said injection system, for example the surface of an injector needle.

The keep-clean and/or clean-up process advantageously comprises the successive steps of:
a) determination of the most suitable supplementation for the fuel, said supplementation corresponding to the selection of the copolymer(s) described above to be incorporated in combination, optionally, with other fuel additives as described previously and the determination of the degree of treatment necessary to achieve a given specification relative to the detergency of the fuel composition;
b) incorporation into the fuel of the selected copolymer(s) in the amount determined in step a) and, optionally, of the other fuel additives.

The copolymer(s) may be incorporated into the fuel, alone or as a mixture, successively or simultaneously.

Alternatively, the copolymer(s) may be used in the form of a concentrate or of an additive concentrate as described above.

Step a) is performed according to any known process and falls within the common practice in the field of fuel supplementation. This step involves defining at least one representative characteristic of the detergency properties of the fuel composition.

The representative characteristic of the detergency properties of the fuel will depend on the type of internal combustion engine, for example a diesel or gasoline engine, the direct or indirect injection system and the location in the engine of the deposits targeted for cleaning and/or maintaining the cleanliness.

For direct-injection diesel engines, the representative characteristic of the detergency properties of the fuel may correspond, for example, to the power loss due to the formation of deposits in the injectors or restriction of the fuel flow emitted by the injector during the functioning of said engine.

The representative characteristic of the detergency properties may also correspond to the appearance of lacquering-type deposits on the injector needle (IDID).

Other methods for evaluating the detergency properties of fuels have been widely described in the literature and fall within the general knowledge of a person skilled in the art. Mention will be made, as nonlimiting examples, of the standardized tests or tests acknowledged by the profession or the methods described in the following publications:

For direct-injection diesel engines:
the DW10 method, standardized engine test method CEC F-98-08, for measuring the power loss of direct-injection diesel engines
the XUD9 method, standardized engine test method CEC F-23-1-01 Issue 5, for measuring the restriction of fuel flow emitted by the injector
the method described by the Applicant in patent application WO 2014/029 770, pages 17 to 20, for the evaluation of lacquering deposits (IDID), this method being cited by way of example.

For indirect injection gasoline engines:
the Mercedes Benz M102E method, standardized test method CEC F-05-A-93, and
the Mercedes Benz M111 method, standardized test method CEC F-20-A-98.
   These methods make it possible to measure the intake valve deposits (IVD), the tests generally being performed on a Eurosuper gasoline corresponding to standard EN228.

For direct injection gasoline engines:
the method described by the Applicant in the article “Evaluating Injector Fouling in Direct Injection Spark Ignition Engines”, Mathieu Arondel, Philippe China, Julien Gueit; Conventional and future energy for automobiles; 10th international colloquium; Jan. 20-22, 2015 [in Stuttgart/Ostfildern; proceedings 2015]; International Colloquium Fuels/Technische Akademie Esslingen by Techn. Akad. Esslingen, Ostfildern; 2015 (ISBN 9783943563160), for evaluation of the coking deposits on the injector, this method being cited by way of example;
the method described in US 2013/0 104 826, for evaluation of the coking deposits on the injector, this method being cited by way of example.

The determination of the amount of copolymer to be added to the fuel composition to achieve the specification will typically be performed by comparison with the fuel composition not containing the copolymer according to the invention.

The amount of copolymer may also vary as a function of the nature and origin of the fuel, in particular as a function of the content of compounds bearing n-alkyl, isoalkyl or n-alkenyl substituents. Thus, the nature and origin of the fuel may also be a factor to be taken into consideration for step a).

The process for maintaining the cleanliness (keep-clean) and/or for cleaning (clean-up) may also comprise an additional step after step b) of checking the target reached and/or of adjusting the amount of supplementation with the copolymer(s) as detergent additive.

The copolymers according to the invention have noteworthy properties as detergent additive in a liquid fuel, in particular in a gas oil or gasoline fuel, in particular block copolymers.

The copolymers according to the invention, in particular the block copolymers according to the invention, are particularly noteworthy especially since they are efficient as detergent additive for a wide range of liquid fuels and/or for one or more types of engine specification and/or against one or more types of deposit which become formed in the internal parts of internal combustion engines.

1. A method for keeping clean and/or for cleaning at least one of the internal parts of an internal combustion engine, said method comprising the introduction in said internal combustion engine of a liquid fuel comprising at least one copolymer comprising at least one repeating unit comprising an alkyl ester or alkylester function and at least one repeating unit comprising at least one hydrocarbon-based group comprising at least two nitrogen atoms.

2. The method as claimed in claim 1, wherein the copolymer is obtained by copolymerization of at least:
one alkyl (meth)acrylate monomer (mₐ), and
one olefinic monomer (m_{b}) comprising at least one hydrocarbon-based group comprising at least two nitrogen atoms.

3. The method as claimed in claim 2, wherein the alkyl (meth)acrylate monomer (mₐ) is chosen from C₁ to C₃₄ alkyl (meth)acrylates.

4. The method as claimed in claim 2, wherein the vinyl monomer (m_{b}) comprising at least one hydrocarbon-based group comprising at least two nitrogen atoms corresponds to formula (I) below: 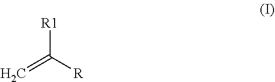
wherein:
R represents a hydrocarbon-based chain comprising from 1 to 24 carbon atoms, comprising at least two nitrogen atoms optionally one or more hydroxyl substituents and optionally comprising one or more groups chosen from: an ether bridge —O—, an ester bridge —COO—, a carbonyl bridge —CO—,
one or more of the nitrogen atoms may be in the form of a quaternary ammonium,
R1 represents H or CH3.

5. The method as claimed in claim 4, wherein the at least two nitrogen atoms are independently present in the group R in the form of a function chosen from: an amine —NH2, an amine bridge —NH—, an imine bridge —N═, an amidine bridge —N═C—N—; a nitrile function —CN, an amide bridge —CONH—, a urea bridge —NH—CO—NH—, a carbamate bridge —O—CO—NH—, a guanidine, alkylguanidine, aminoguanidine, biguanidine, polyamine or polyalkylene-polyamine group, a quaternary ammonium.

6. The method as claimed in claim 2, wherein the monomer (m_{b}) is represented by formula (Ia): 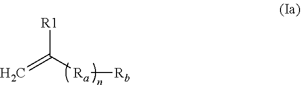
wherein:
n represents an integer chosen from 0 and 1,
Ra represents a linear, branched or cyclic C₁-C₁₂ alkyl or C₂-C₁₂ alkenyl chain, optionally comprising one or more ether bridges —O—, an amine bridge —NH—, an imine bridge —N═, a carbonyl bridge —CO—, an ester bridge —COO—, a carboxyl bridge —OCO—, an amide bridge —CONH—, a urea bridge —NH—CO—NH—, a carbamate bridge —O—CO—NH—,
Rb represents a nitrogenous heterocycle comprising at least two nitrogen atoms,
one or more of the nitrogen atoms of Ra and/or of Rb may be in the form of a quaternary ammonium,
R1 represents H or CH₃.

7. The method as claimed in claim 6, wherein Ra represents a C₁-C₈ alkyl chain optionally comprising a carbonyl bridge —CO—, and Rb is chosen from rings comprising five atoms and rings comprising six atoms, these rings comprising two or three nitrogen atoms, and two, three or four carbon atoms.

8. The method as claimed in claim 2, wherein the copolymer is a block copolymer comprising at least:
one block A consisting of a chain of structural units derived from the alkyl (meth)acrylate monomer (mₐ), and
one block B₁ consisting of a chain of structural units derived from the olefinic monomer (na_{b}).

9. The method as claimed in claim 1, comprising before the introduction of the liquid fuel in the internal combustion engine:
1) the preparation of a concentrate for fuel comprising one or more copolymers as described in claim 1, as a mixture with an organic liquid, said organic liquid being inert with respect to the copolymer(s) and miscible with said fuel, and
2) the introduction of said concentrate for fuel in the liquid fuel.

10. The method as claimed in claim 1, comprising, before the introduction of the liquid fuel in the internal combustion engine, the addition to the liquid fuel of
one or more copolymers as described in claim 1.

11. (canceled)

12. The method as claimed in claim 1, wherein the copolymer is added to the liquid fuel to avoid and/or reduce the formation of deposits in at least one of the internal parts of said engine and/or to reduce the existing deposits in at least one of the internal parts of said engine.

13. The method as claimed in claim 1, for reducing the fuel consumption of an internal combustion engine.

14. The method as claimed in claim 1, for limiting or reducing or avoiding or preventing the pollutant emissions of an internal combustion engine.

15. The method as claimed in claim 1, wherein the internal combustion engine is a spark ignition engine.

16. The method as claimed in claim 15, for limiting or reducing or avoiding or preventing the formation of deposits in at least one internal part of a spark ignition engine chosen from the engine intake system, the combustion chamber, the fuel injection system.

17. The method as claimed in claim 1, wherein the internal combustion engine is a diesel engine.

18. The method as claimed in claim 17, for limiting or reducing or avoiding or preventing the formation of deposits in the injection system of the diesel engine.

19. The method as claimed in claim 18, for limiting or reducing or avoiding or preventing the formation of deposits associated with coking and/or deposits of soap and/or lacquering type.

20-35. (canceled)
